(19) United States
(12) Patent Application Publication
(10) Pub. No.: US 2007/0231777 A1
(43) Pub. Date: Oct. 4, 2007

(54) Personal and career management system

(76) Inventor: Anthony M. Dimarco, Poughkeepsie, NY (US)

Correspondence Address: HESLIN ROTHENBERG FARLEY & MESITI PC, 5 COLUMBIA CIRCLE, ALBANY, NY, 12203, US

(21) Appl. No.: 11/716,943

(22) Filed: Mar. 12, 2007

Related U.S. Application Data
(60) Provisional application No. 60/788,026, filed on Mar. 30, 2006.

(51) Int. Cl. G09B 19/00

(52) U.S. Cl. 434/219

(57) ABSTRACT

A comprehensive and visual personal career management system, designed first and foremost for the individual, and comprised of three distinct sets of functionality that answer three ongoing and critical career management questions: Where am I now? (Career Assessment), Where do I really want to be? (Career Exploration), and How do I get there? (Personal Marketing & Development). A differentiating approach of applying data visualization techniques to career data by enabling a person to capture, assess, and communicate their comprehensive career experiences in a compelling visual way.

The present application is related to provisional patent application Ser. No. 60/788,026, filed Mar. 30, 2006. This utility application is also related to patent application Ser. No. 10/379,188 filed on Mar. 6, 2003 and published by the Patent Office on Sep. 18, 2003, Publication No. US-2003-0177027-A1. It is also related to patent application Ser. No. 10/998,848 filed on Nov. 29, 2004 and published by the Patent Office on Jun. 1, 2006, Publication No. US-2006-0116894-A1. All of these applications are incorporated herein by this reference and the benefit of the filing date of the provisional applications Ser. No. 60/788,026, filed Mar. 30, 2006, is claimed herein as well.

### BACKGROUND OF THE INVENTION

1. Field of the Invention

Personal career management is designed first and foremost for the individual. It is comprised of three distinct sets of functionality that answer three ongoing and critical career management questions: Where am I now? (Career Assessment), Where do I really want to be? (Career Exploration), and How do I get there? (Personal Marketing & Development).

Where an I now? This question is all about using career assessment methods for developing deep self-knowledge or what the present invention refers to as “discovering your Natural Center”. An individual can discover their Natural Center by answering four questions:
What am I really good at? (Natural Talents)
What do I really love to do? (Core Passion)
What is really important to me? (Core Values)
What do I get a deep sense of satisfaction from? (Core Purpose).

Where do I really want to be? This question is not easily answered unless you have answered the previous question that led to deep self-knowledge. Answering this question involves “exploring” and considering a wide range of options one might not have thought of before.

How do I get there? Answering this question also requires one to have answered the prior two questions which help identify the starting point (where am I now) and the destination (where do I really want to be). A key element in answering this question is the ability to develop a specific plan for moving forward which could include activities such as research on specific job opportunities, exploratory interviews, networking, further education or stepping stone career experiences. Another key part is personal marketing—being able to market yourself effectively for a highly desirable job.

The present invention, in the area of visual personal career management, includes a visual structured framework and set of visual online capabilities that enables an individual to answer the three critical person career management questions: Where am I now?, Where do I really want to be?, and How do I get there? It translates and correlates these questions to three specific sets of online functionality—Career Assessment, Career Exploration, and Personal Marketing & Development, respectively.

The present invention provides new capabilities that build on and utilize the capabilities provided through patent application Ser. No. 10/379,188 and Ser. No. 10/998,848. The new career assessment capabilities include a visual depiction and menu structure for completing a Visual Portfolio and Visual Resume. In addition, it provides new assessment functions for identifying transferable competencies, a career mobility profile, and the ability to identify Natural Roles, which is a specific and practical method for identifying a person's Natural Center. The new career exploration capabilities include a job board search feature, that enable searching by structured fields that are part of the taxonomy structure of the NavAgility Career View (i.e., the two dimensional visual depiction of a person's career experiences). The new personal marketing capabilities include the ability to customize an email signature block that includes a link to a person's Career View and/or Visual Resume (i.e., the three dimensional visual depiction of a person's comprehensive career experiences.) It also includes a capability for creating a two-minute career story that augments the person's Career View and Visual Resume. It also includes the ability to select specific Views from the graphical representation of the Visual Portfolio, and a mechanism for sharing these Views by including them as links in an email. It also includes the ability to participate in Online Talent Showcases that are visual online mechanisms for presenting pre-selected groups of individuals, through their Career Views, to pre-selected sets of recruiters and hiring managers.

A significant and differentiating component of the present invention comes from the visual representation of career experiences. The benefits of data visualization have been known for centuries and practiced just as long. In his seminal book, The Visual Display of Quantitative Information, Edward R. Tufte points out, “Often the most effective way to describe, explore, and summarize a set of numbers—even a very large set—is to look at pictures of those numbers. Furthermore, of all the methods for analyzing and communicating statistical information, well designed data graphics are usually the simplest, and at the same time the most powerful.” (See Tufte, Edward R. “The Visual Display of Quantitative Information”, Chesire, Conn.: Graphics Press LLC, 2001). What executive today would be satisfied with analyzing business results by looking only at mountains of data? The patterns and trends would be totally lost in the data. The present invention extends the differentiating approach of applying data visualization techniques to career data by enabling a person to capture, assess, and communicate their comprehensive career experiences in a compelling visual way.

2. Description of the Prior Art

The state of prior art for personal career management is primarily focused on capturing skills. These are often referred to as Skills Management systems. Their design point is usually targeted at helping a Human Resources organization capture employee data that can be used for control purposes such as resource management and resource deployment. This is diametrically opposed to the present invention which is a Personal Career Management system designed first and foremost for the individual. In addition, the prior art of skills and competency management systems are text based versus the visual/graphical approaches of the present invention. A common skills management approach is disclosed in U.S. Pat. No. 6,275,812 by Haq et al., entitled “Intelligent

Pertaining to the present invention approach of helping individuals develop deep self-knowledge through a method for discovering their Natural Center and Natural Roles, there is no known prior art.

### SUMMARY OF THE INVENTION

An object of the present invention is to provide a mechanism that provides a comprehensive and visual personal career management system for individuals comprised of career assessment, career exploration and personal marketing and development capabilities.

The present invention is comprised of three visual functional frameworks and navigation schemes and five major functions:
Visual Portfolio functional framework and navigation—a graphical depiction of the various Views for the visual capture and communication of comprehensive, multi-dimensional career experiences.
Natural Center functional framework and navigation—for the surfacing of deep self-knowledge through the present embodiment of the present invention which includes three functions:
   Transferable Competencies—for the capture and prioritization of a portfolio of transferable competencies that include transferable roles, skills, knowledge, and strengths.
   Career Mobility Profile—for the visual representation of diversity of career experiences across many dimensions that include companies, jobs, career areas, disciplines, projects, roles, skills, and knowledge.
   Natural Roles—for the surfacing and prioritization of traditional roles and the translation of these traditional role labels into descriptions and highly targeted Natural Role labels which are roles at the intersection of the individual's Natural Talents (what they are really good at), Core Passion (what they really like to do), Core Value (what is really important to them), and their Core Purpose (what they derive a deep sense of satisfaction from).
Personal Marketing functional framework and navigation—for the communication of comprehensive, multi-dimensional career experiences through the present embodiment of the present invention which includes four major functions:
   Email Signature Block—for the inclusion of a link to an individual's Career and/or their Visual Resume in their email signature block, thus turning every email sent into a personal marketing message.
   Career Story—for the creation of a two minute audio clip attached to the individual's Career View and Visual Resume.
   Send Portfolio—for the visual packaging and communication of a custom set of Views that can be attached to an email via simple links.
   Online Talent Showcase—for presenting pre-selected groups of individuals via his or her Career View, to pre-selected groups of hiring managers and recruiters.

### BRIEF DESCRIPTION OF THE DRAWINGS

For a more complete understanding of the present invention, reference is now made to the following descriptions taken in conjunction with the accompanying drawings, in which:

FIG. 1 is the present embodiment of the Visual Portfolio functional framework and navigation—a graphical depiction of the various Views for the visual capture and communication of comprehensive, multi-dimensional career experiences. It is used by individuals to select which View (or dimension) of their career experiences they want to capture.

FIG. 2A represents the present embodiment of the Natural Center functional framework and navigation.

FIG. 2B represents and example of the Transferable Competencies function which helps an individual capture and prioritization of a portfolio of transferable competencies that include transferable roles, skills, knowledge, and strengths.

FIG. 2C represents an example of a Career Mobility Profile which helps an individual quickly and automatically assess through a visual representation, the diversity of career experiences across many dimensions that include companies, jobs, career areas, disciplines, projects, roles, skills, etc.

FIG. 2D represents an example of one step in the Natural Roles function which is used to translate traditional role labels into unique descriptions and labels called Natural Roles which are representative of a person working at his or her Natural Center.

FIG. 3A is the present embodiment of the Personal Marketing functional framework and navigation which is used to navigate or select various personal marketing functions that include but are not limited to those represented by FIGS. 3B-3D. FIG. 3B is the present embodiment of the Email Signature Block function which enables an individual to include a link to his or her Career and/or Visual Resume in his or her email signature block, thus turning every email sent into a personal marketing message. FIG. 3C is the present embodiment of the Career Story function used to creation a two minute audio clip which is then attached to the individual's Career View and Visual Resume. FIG. 3D is the present embodiment of the Send Portfolio function used to visually package (i.e., merchandise) and communicate of a custom set of Views that can be attached to an email via simple links. FIG. 3E is the present embodiment of the Online Talent Showcase function used to visually present pre-selected groups of individuals via his or her Career View, to pre-selected groups of hiring managers and recruiters.

### DETAILED DESCRIPTION OF INVENTION

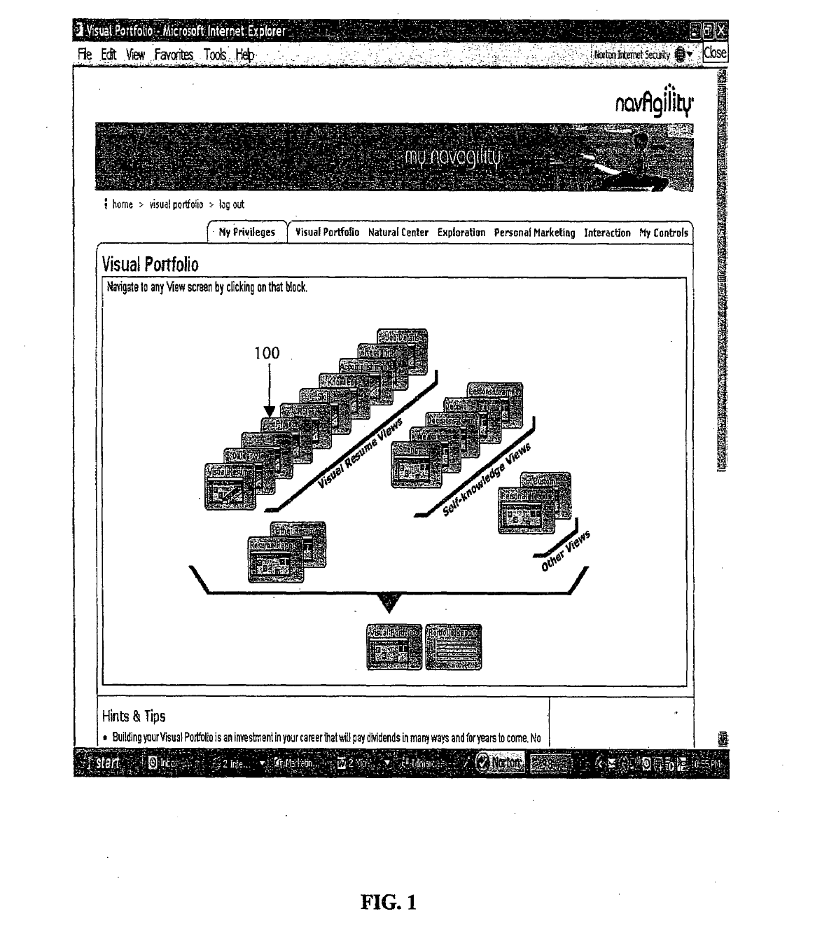

FIG. 1 is the present embodiment of the Visual Portfolio functional framework and navigation—a graphical depiction of the various Views for the visual capture and communication of comprehensive, multi-dimensional career experiences. It is used by individuals to select which View (or dimension) of their career experiences they want to capture. This is done simply by selecting the graphical icon for the desired View, such as the Project View 100. It represents a major career assessment component of the personal career management framework and the process of creating and analyzing their Visual Portfolio results in new insights and deep self-knowledge. It represents a complete and comprehensive history of their career experiences and as such it also used as review before an interview.

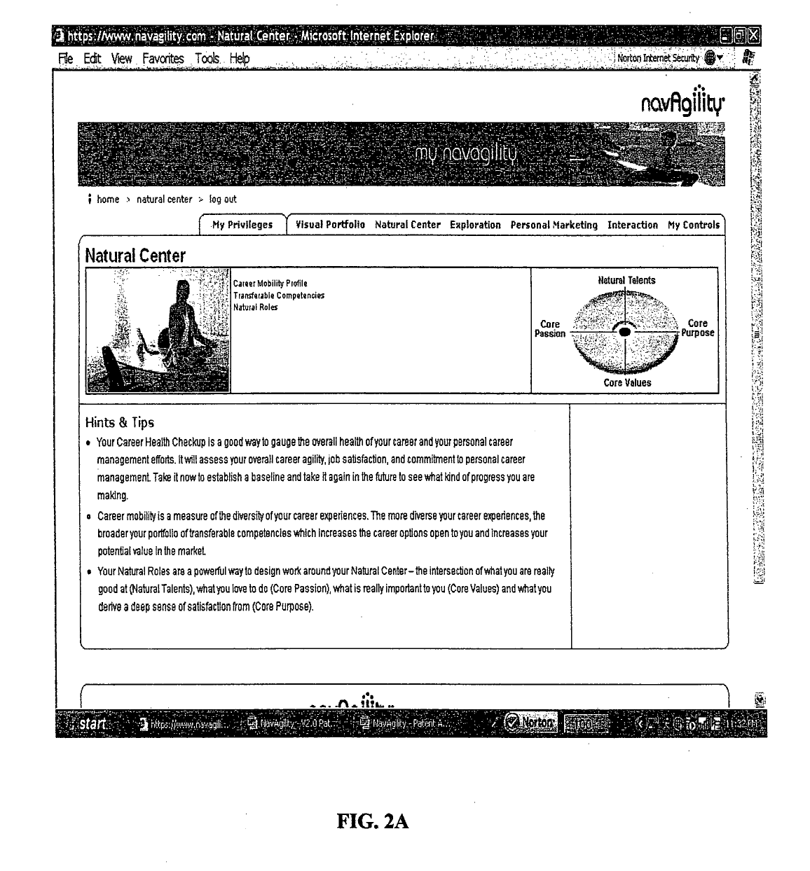

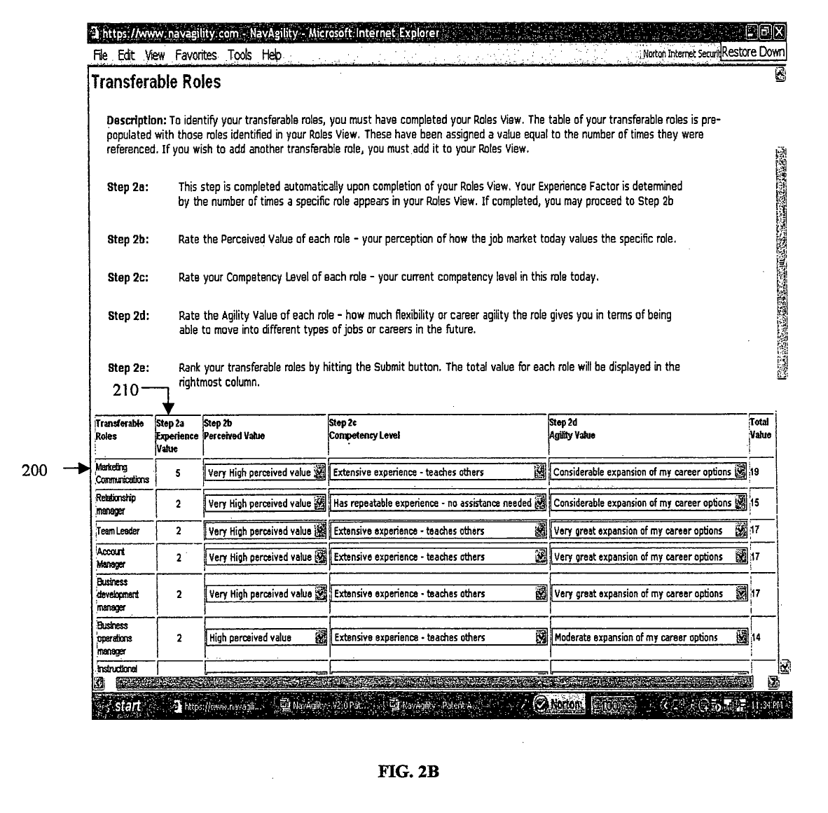

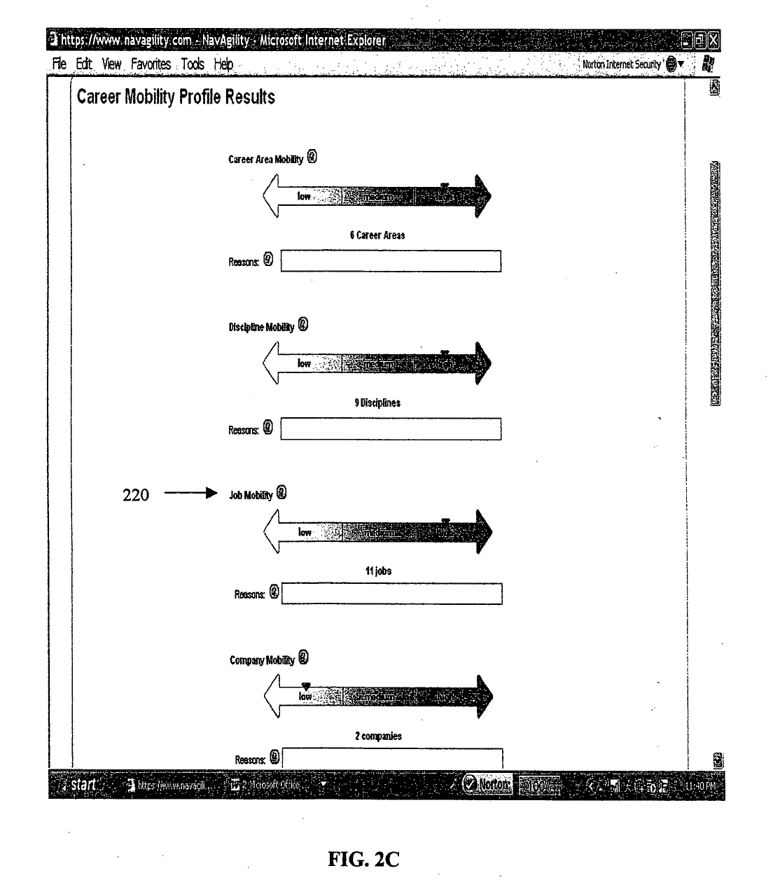

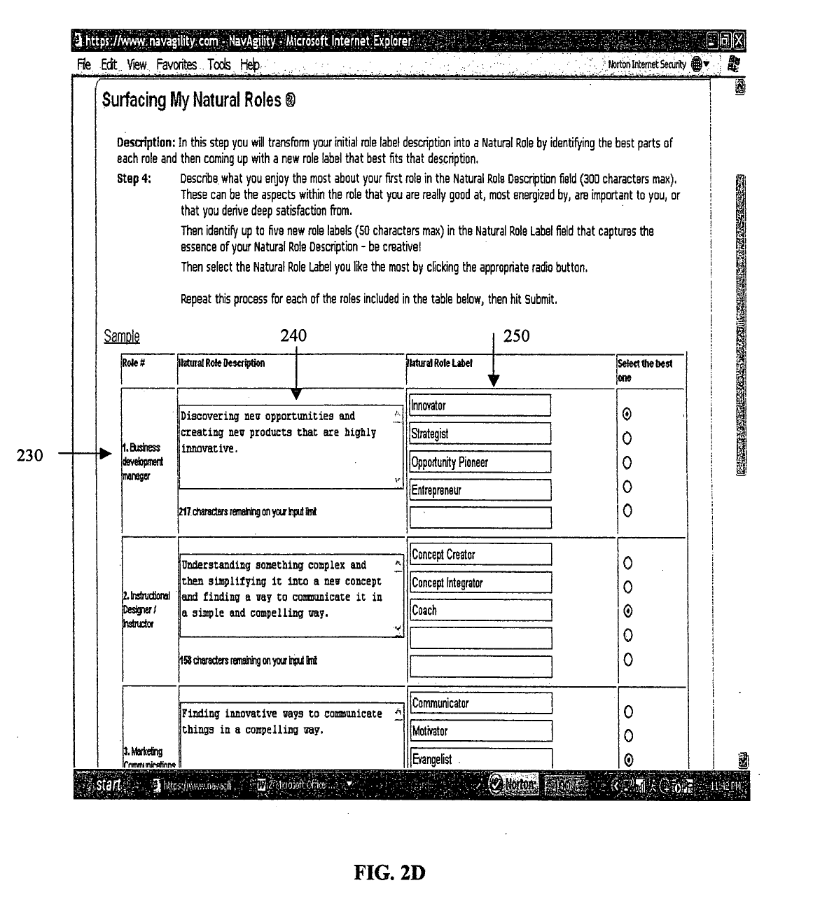

FIG. 2A represents the present embodiment of the Natural Center functional framework and navigation. It represents a visual depiction of a person's Natural Center being at the intersection of intersection of the individual's Natural Talents (what they are really good at), Core Passion (what they really like to do), Core Value (what is really important to them), and their Core Purpose (what they derive a deep sense of satisfaction from). FIGS. 2B-2D represents the present embodiment of the Natural Center including three functions: FIG. 2B Transferable Competencies, FIG. 2C Career Mobility Profile, FIG. 2D Natural Roles.

FIG. 2B represents and example of the Transferable Competencies function which helps an individual capture and prioritization of a portfolio of transferable competencies that include transferable roles, skills, knowledge, and strengths. These are in all three components of the personal career management framework: they offer valuable new insights of differentiating competencies (career assessment), they open up new career options (career exploration), and they offer a more powerful way to market oneself for a new job (personal marketing). Transferable competencies are comprised of transferable roles, skills, knowledge, and strengths with each based on the corresponding View within the Visual Portfolio. FIG. 2B is an example of the Transferable Roles function with each row 200 representing a role populated automatically from the Roles View based and ordered and rated 210 based on the number of times a role was played. For each role, the individual then self rates each role for the perceived value of that role in the market today, the individual's competency level for that role, and the Agility Value or the perceived amount of career options this role might open up for the individual.

FIG. 2C represents an example of a Career Mobility Profile which helps an individual quickly and automatically assess through a visual representation, the diversity of career experiences across many dimensions that include companies, jobs, career areas, disciplines, projects, roles, skills, etc. Each arrow represents one dimension of mobility that results in some level of diversity of experience. An example dimension is Job Mobility 220 where low mobility is indicated by having 1 to 5 jobs, medium mobility by 6 to 10 jobs, and high mobility by greater than 10 jobs. This rating is calculated automatically from the number of jobs on the person's Career View. It gives a person a quick sense of where (i.e., which dimension) they could benefit from additional diverse experiences.

FIG. 2D represents an example of one step in the Natural Roles function which is used to translate traditional role labels 230 into unique descriptions 240 and labels 250 called Natural Roles which are representative of a person working at his or her Natural Center. The traditional role labels are placed and prioritized automatically from the Roles View and then further prioritized through a prior Natural Roles step. In the step following the one represented in FIG. 2D the Natural Roles are rated and prioritized which validates that a specified Natural Role does actually qualify as a Natural Role which is an example of the person operating at the intersection of the individual's Natural Talents (what they are really good at), Core Passion (what they really like to do), Core Value (what is really important to them), and their Core Purpose (what they derive a deep sense of satisfaction from). Therefore Natural Roles is a practical and valuable embodiment of the Natural Center framework and method. It is highly valued on all three dimensions of personal career management—driving totally new insights and language representing a person's unique capabilities (assessment), it opens up totally new opportunities (exploration), and provides powerful new language with which to describe and market oneself (personal marketing).

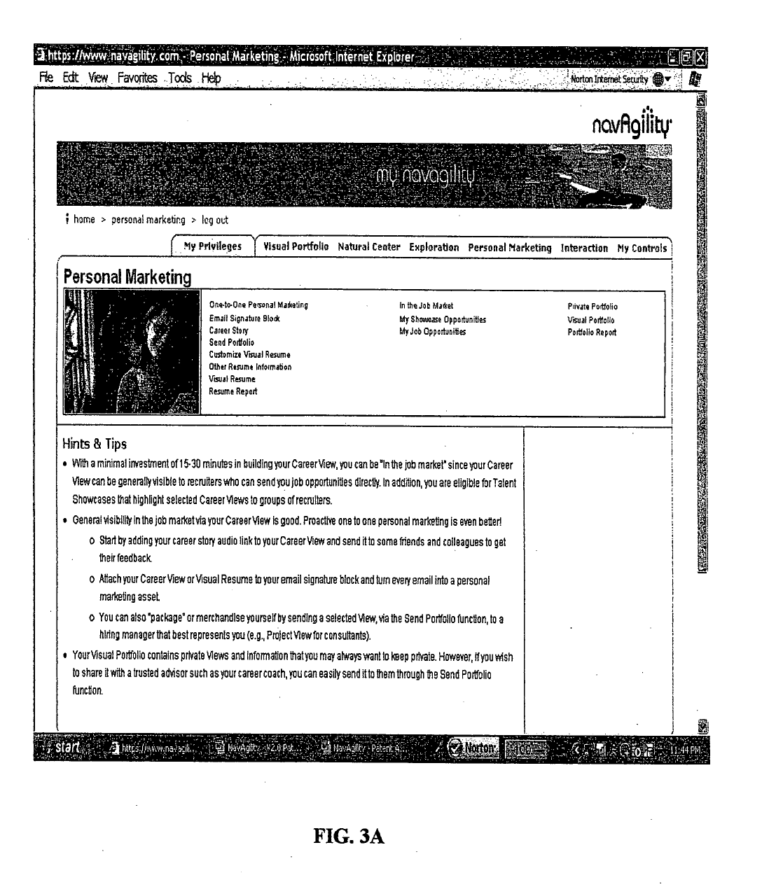

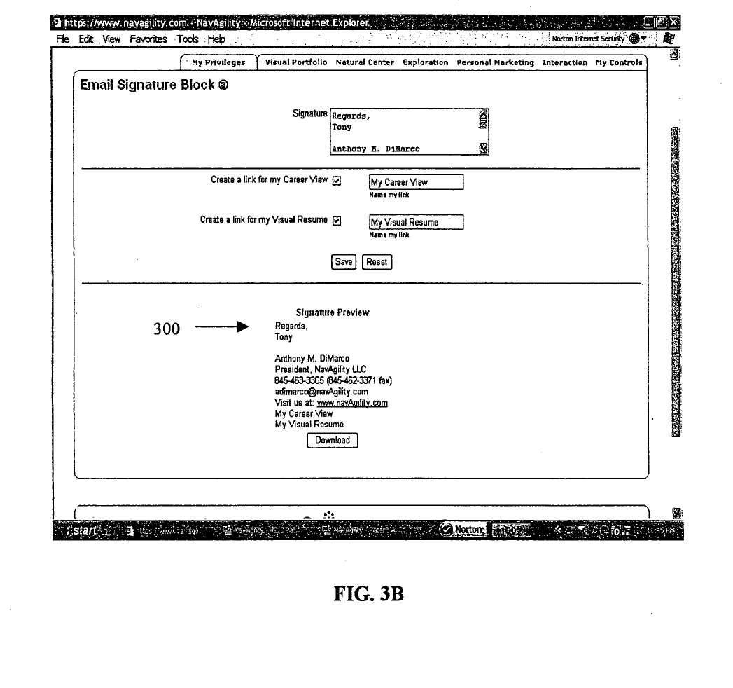

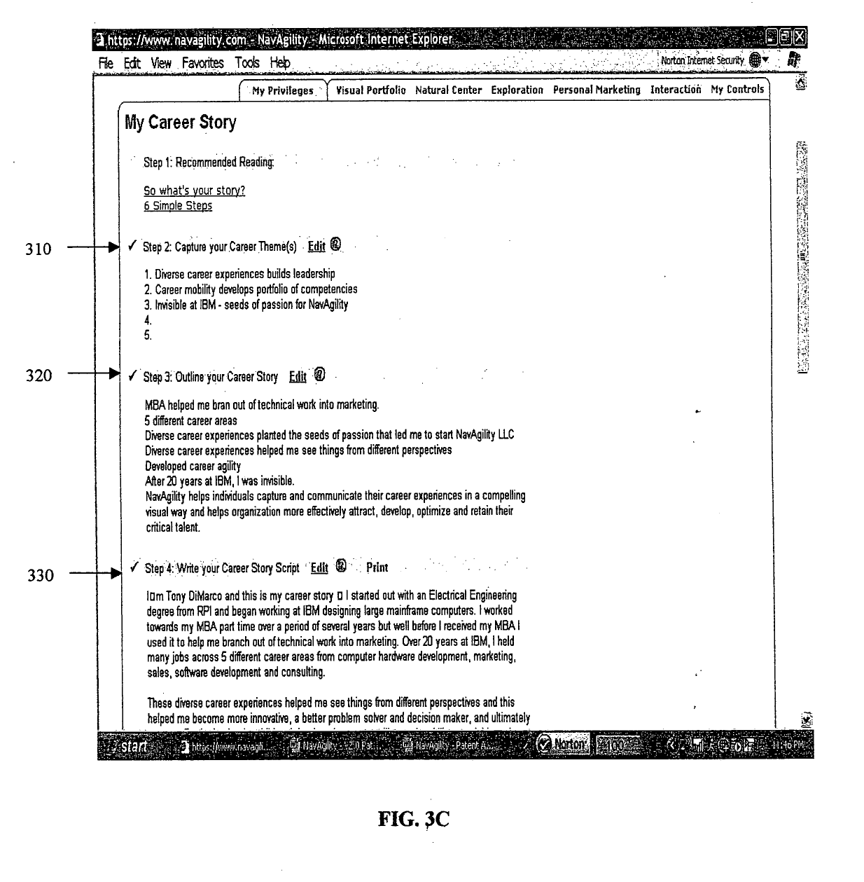

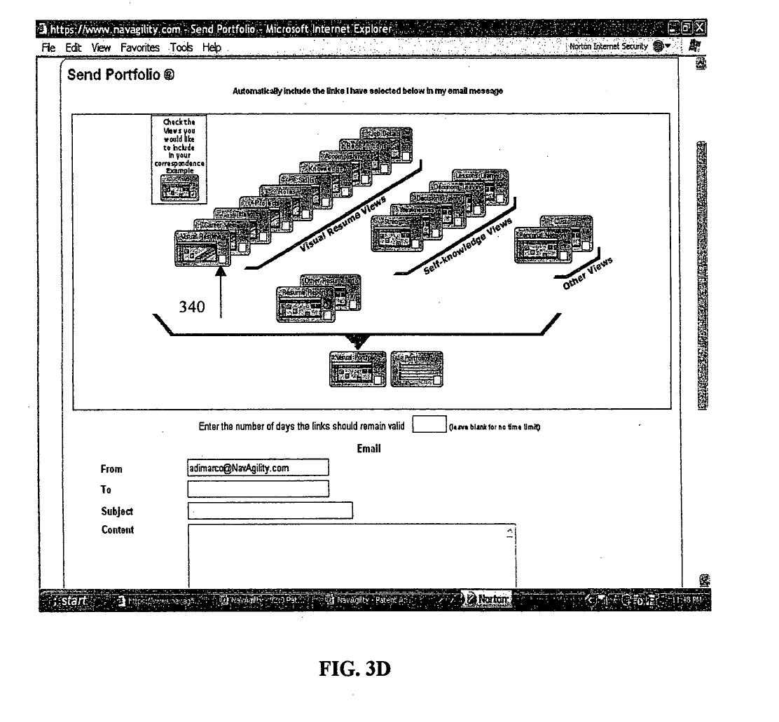

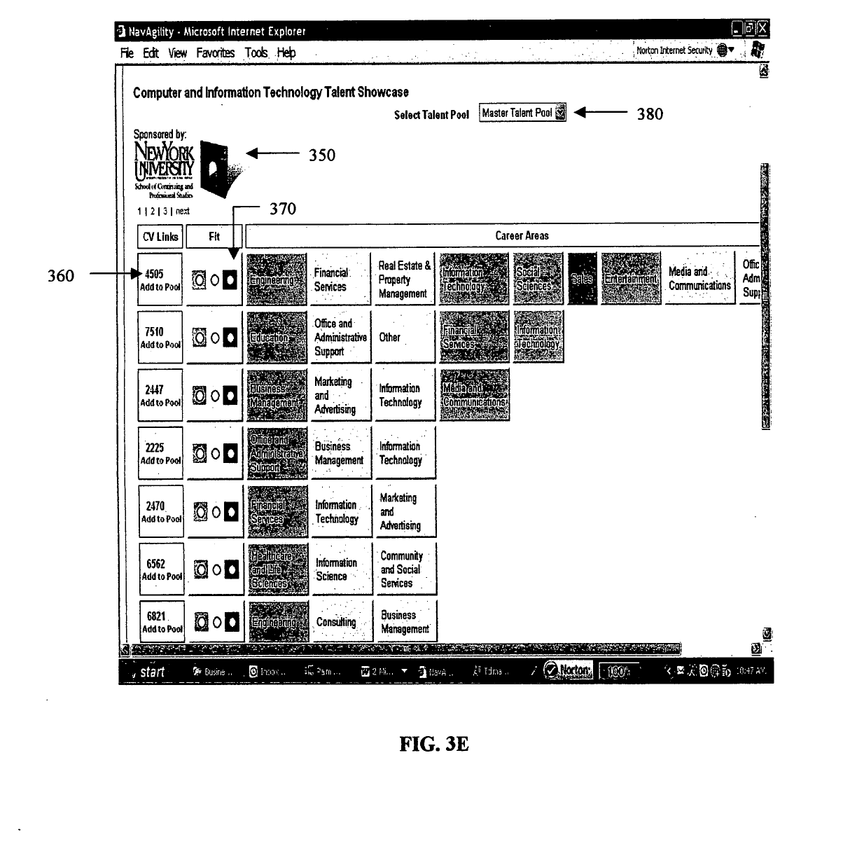

FIG. 3A is the present embodiment of the Personal Marketing functional framework and navigation which is used to navigate or select various personal marketing functions that include but are not limited to those represented by FIGS. 3B-3D. They are focused on enhancing the ability of the individual to differentiate themselves in a crowded job market through more effective and compelling abilities to communicate their unique value proposition.

FIG. 3B is the present embodiment of the Email Signature Block function which enables an individual to include a link to his or her Career and/or Visual Resume in his or her email signature block, thus turning every email sent into a personal marketing message. The email signature block, as created by the individual, can be previewed 300 and then downloaded to a local computer as a signature file ready to include in various email services such as Microsoft's Outlook.

FIG. 3C is the present embodiment of the Career Story function used to creation a two minute audio clip which is then attached to the individual's Career View and Visual Resume. The Career Story is crafted first by identifying the common themes 310 or threads that weave through a set of career experiences, creating coherency through additional context. These themes then become the basis for outlining 320 the career story and then writing the script 330 for the career story. The script function counts the number of words used since we recommend a two minute audio story and that translates to approximately 400 written words. The actual capture of the audio clip is done outside of this present embodiment through the use of a digital recording device. A separate function is used to upload attach the audio clip to the Career View. The Career Story is a powerful personal marketing tool often referred to as your “elevator pitch”.

FIG. 3D is the present embodiment of the Send Portfolio function used to visually package (i.e., merchandise) and communicate of a custom set of Views that can be attached to an email via simple links. The graphical depiction is the same as that used to capture the Visual Portfolio in FIG. 1 except for the ability to select via check boxes 340 which Views to include in an email sent to a specific person such as a hiring manager, recruiter, career coach or mentor.

FIG. 3E is the present embodiment of the Online Talent Showcase function used to visually present pre-selected groups of individuals via his or her Career View, to pre-selected groups of hiring managers and recruiters. An individual participates in a sponsored 350 showcase through an invitation/acceptance process enabled by the Showcase Coordinator function of the present invention. An Online Talent Showcase runs for a specified period, during which time, the individual's Career View is visible as a row 360 in the Showcase. Participating recruiters can view the Career View by selecting the Member Id link 360 and they can use the Fit 370 rating mechanism to determine if a Career View is a high, medium or poor fit for the talent they are seeking. A recruiter can also add a specific Career View to an unlimited number of talent pools 380 that they have previously specified. System for Dynamic Resource Management.” In this approach, skills data is captured in text format via templates and weighted in order to establish relative significance of various skills.

Other similar examples of prior art also focus on capturing skills but for different applications. One such application is called Learning Management. A common learning management approach is disclosed in U.S. Pat. No. 6,996,366 by L'Allier, et al., entitled “Automated individualized learning program creation system and associated methods.” In this approach, skills are captured through a natural language text based method that enables identification of gaps between the skills currently possessed by an individual and those skills they aspire to possess, and then training recommendations are made that can help close the gap.

There are numerous human resource applications, all designed to capture employee information for use by the human resource organization for control purposes. These include the skills management and learning management systems described above, but can also include other applications such as Performance Management and Leadership Succession Planning. While these prior art applications are numerous they all possess one common trait and flaw—they all depend on capturing employee skill or competency data and they all have a control system design point. As a result, most, if not all of these approaches have failed because the individual receives little value and is well aware of the control system design point. Human Resource organizations that use these applications, therefore often resort to compliance driven approaches that force employees to enter their data, or else his or her promotions, annual bonuses or raises will be jeopardized. Even with such heavy handed methods, compliance is underwhelming in its effectiveness and the applications often fail due to lack of data input by individuals.

The present invention has a design point of providing value to the individual by providing compelling value through a comprehensive and visual personal career management system. The skills and competencies that result are presented visually in order to increase the value to the individual and to motivate usage. The end result is more comprehensive, structured data captured through value-driven versus compliance driven approach, and with the added benefit of being able to visualize the data.

What I claim as my invention is:

1. A comprehensive and visual personal career management system for individuals comprised of career assessment, career exploration and personal marketing and development capabilities, the system comprising:
a server including a memory
a means for navigating, creating and communicating a multi-dimensional,
structured, visual portfolio of comprehensive career experiences
a means for visually displaying and navigating through a person's natural center
a means for identifying and prioritizing an individual's transferable competencies
a means for visually capturing and displaying a career mobility profile
a means for creating a career story in a step wise fashion
a means for visually packaging and communicating a custom set of views via links in an email
a means for visually presenting, pre-selected groups of individuals via his or her views, to pre-selected groups of people.

2. The system of claim 1 wherein the visual portfolio includes graphical icons which are selectable for navigation to specific views or dimensions of the portfolio.

3. The system of claim 1 including a means for visually depicting a graphical framework for one's unique and core differentiators comprised of the individual's natural talents, core passion, core value and their core purpose.

4. The system of claim 3 including a means to navigate to specific functions that comprise the ability to comprise one's unique and core differentiators.

5. The system of claim 1 including a means for capturing transferable competencies including but not limited to transferable roles, skills, knowledge and strengths.

6. The system of claim 5 including a means for automatically including transferable competency elements directly from the graphical views in a person's visual portfolio.

7. The system of claim 5 including in a means for ranking and prioritizing a complete set of transferable competencies within each transferable competency type.

8. The system of claim 1 including a means for identifying a career mobility profile including but not limited to the mobility dimensions of company, career area, job, discipline, project, roles, skills, and knowledge.

9. The system of claim 8 including a means for automatically calculating and visually displaying a mobility measure directly from the graphical views in a person's visual portfolio.

10. The system of claim 1 including a means for determining one's natural roles.

11. The system of claim 10 including a means for automatically including and prioritizing and assigning an experience value to roles specified in the graphical roles views in a person's visual portfolio.

12. The system of claim 11 including a means for self-rating and prioritizing each role against four criteria that guarantee uniqueness, those criteria including natural talents, core passion, core purpose and core values.

13. The system of claim 11 including a means for describing the unique elements of each prioritized role and then identifying new role labels which capture the essence of this description and then selecting the most appropriate role label from the several identified.

14. The system of claim 13 including a means for self-rating each natural role in order to validate it represents a person's natural center including natural talents, core passion, core purpose and core values.

15. The system of claim 13 including a means to fine tune the description for the top two natural roles.

16. The system of claim 1 including a means for an individual to create an email signature block that includes links to his or her visual views.

17. The system of claim 16 including a means to download the email signature block to local computer storage to facilitate inclusion in the person's email services.

18. The system of claim 1 including a means for outlining and scripting a 400 word career story.

19. The system of claim 18 including a means for displaying the words used in the career story script.

20. The system of claim 1 including a means for selecting graphical components representing different views of a person's visual portfolio.

21. The system of claim 20 including a means to include the selected graphical views as links in an email that can be crafted and sent to a specific person.

22. The system of claim 1 including the means for an individual to be invited and accepted to participate in an online talent showcase.

23. The system of claim 22 including the means for other people to be invited to participate in an online talent showcase.

24. The system of claim 22 including the means to include the views of an individual in the online talent showcase.

25. The system of claim 22 including the means for another person to browse an individual's views within the online talent showcase

26. The system of claim 22 to assess fit, and to add selected views to a selected talent pool which they previously specified.

27. The method of managing one's career comprised of career assessment, career exploration and personal marketing and development, the method comprising steps of:
navigating, creating and communicating a multi-dimensional, structured,
visual portfolio of comprehensive career experiences
visually displaying and navigating through a person's natural center
identifying and prioritizing an individual's transferable competencies
visually capturing and displaying a career mobility profile
creating a career story in a step wise fashion
visually packaging and communicating a custom set of views via links in an email
visually presenting pre-selected groups of individuals via his or her views, to pre-selected groups of people.

28. The method of claim 27 including selecting specific views of the portfolio.

29. The method of claim 27 of visually depicting a graphical framework for one's unique and core differentiators comprised of the individual's natural talents, core passion, core value, and their core purpose.

30. The method of claim 29 including navigating to specific functions that comprise the ability to comprise one's unique and core differentiators.

31. The method of claim 27 of capturing transferable competencies including but not limited to transferable roles, skills, knowledge and strengths.

32. The method of claim 31 including automatically including transferable competency elements directly from the graphical views in a person's visual portfolio.

33. The method of claim 31 including ranking and prioritizing a complete set of transferable competencies within each transferable competency type.

34. The method of claim 27 including identifying a career mobility profile including but not limited to the mobility dimensions of company, career area, job, discipline, project, roles, skills, and knowledge.

35. The method of claim 34 of automatically calculating and visually displaying a mobility measure directly from the graphical views in a person's visual portfolio.

36. The method of claim 1 including determining one's natural roles.

37. The method of claim 36 including automatically including and prioritizing and assigning an experience value to roles specified in the graphical roles views in a person's visual portfolio.

38. The method of claim 37 including self-rating and prioritizing each role against four criteria that guarantee uniqueness including natural talents, core passion, core purpose and core values.

39. The method of claim 37 including describing the unique elements of each prioritized role and then identifying new role labels which capture the essence of this description and then selecting the most appropriate role label from the several identified.

40. The method of claim 39 including self-rating each natural role in order to validate it represents a person's natural center including natural talents, core passion, core purpose and core values.

41. The method of claim 39 including fine tuning the description for the top two natural roles.

42. The method of claim 27 of creating an email signature block that includes links to his or her visual views.

43. The method of claim 27 including downloading the email signature block to local computer storage to facilitate inclusion in the person's email services.

44. The method of claim 27 including outlining and scripting a 400 word career story.

45. The method of claim 44 of displaying the words used in the career story script.

46. The method of claim 27 including selecting graphical components representing different views of a person's visual portfolio.

47. The method of claim 46 including the including of selected graphical views as links in an email that can be crafted and sent to a specific person.

48. The method of claim 27 including inviting and being accepted to participate in an online talent showcase.

49. The method of claim 48 including being invited to participate in an online talent showcase.

50. The method of claim 48 including the including of views of an individual in the online talent showcase.

51. The method of claim 48 including browsing an individual's views within the online talent showcase

52. The method of claim 48 including assessing fit, and adding selected views to a selected talent pool which previously specified.
